(19) United States
(12) Patent Application Publication
(10) Pub. No.: US 2008/0150506 A1
(43) Pub. Date: Jun. 26, 2008

(54) Power controller having a single digital control pin and method utilizing same

(75) Inventors: Andrew Martin Cowell, Greytown (NZ); Lok-Cheung Fong, Cupertino, CA (US)

Correspondence Address: DORSEY & WHITNEY LLP, 555 CALIFORNIA STREET, SUITE 1000, SUITE 1000, SAN FRANCISCO, CA, 94104, US

(73) Assignee: Micrel, Incorporated

(21) Appl. No.: 11/542,690

(22) Filed: Oct. 2, 2006

(51) Int. Cl. G05F 1/00

(52) U.S. Cl. 323/283

(57) ABSTRACT

A power regulator having a single digital control pin for controlling the amount of power delivered to a load is provided. The single digital control pin is set to a first logic state for a first predetermined amount of time to specify a first power control function to be executed by the power regulator. The first power control function is executed by toggling the single digital control pin between the first logic state and a second logic state. A method for controlling the amount of power delivered to a load is also provided.

### FIELD OF THE INVENTION

The present invention relates generally to power controllers, and more particularly to power controllers for controlling the amount of power delivered to a load.

### BACKGROUND INFORMATION

Power controllers have been provided to regulate the power delivered to a load. Typical power controllers control the power delivered to the load using conventional feedback and compensation internal circuitry that may be implemented with a combination of analog and digital components. A power controller integrated circuit may also have an enable pin to enable power delivery to the load and to disable the power controller.

The amount of power that is delivered to the load may be controlled externally. External control circuits may interface with the power controllers to specify power control functions to be executed by the power controllers. Those functions may include adjusting the output voltage or current delivered to the load, adjusting the duty cycle of the power controller, and controlling the power up and shutdown of the power controller, among others.

Traditionally, controlling power control functions within a power controller has required external control circuits interfacing with the power controller through multiple pins. For example, U.S. Patent Publication No. 2004/0196018 discloses an external digital control circuit for limiting the duty cycle of a power controller, U.S. Patent Publication No. 2004/0150928 discloses an external digital control circuit for providing pulse width modulated control signals to power controllers for controlling power switches in the power controllers, and U.S. Pat. No. 6,819,011 discloses a digital controller circuit for controlling the shutdown of a plurality of power controllers providing power to a microprocessor.

There remains, however, a need to control power control functions with fewer resources.

### SUMMARY OF THE INVENTION

In view of the foregoing, a power regulator having a single digital control pin for controlling the amount of power delivered to a load is provided. The single digital control pin is set to a first logic state for a first predetermined amount of time to specify a first power control function to be executed by the power regulator. The first power control function is executed by toggling the single digital control pin between the first logic state and a second logic state. A method for controlling the amount of power delivered to a load is also provided.

### BRIEF DESCRIPTION OF THE DRAWINGS

The accompanying drawings, which are somewhat schematic in some instances and are incorporated in and form a part of this specification, illustrate several embodiments of the invention and, together with the description, serve to explain the principles of the invention.

FIG. 1 shows an exemplary schematic diagram of a power controller designed in accordance with the present invention;

FIG. 2 is a flowchart showing exemplary steps for controlling a power controller using a single digital control pin in accordance with the present invention;

FIG. 3 shows an exemplary timing diagram illustrating the operation of the power controller in response to a digital control signal;

FIG. 4 shows another exemplary timing diagram illustrating the operation of the power controller in response to a digital control signal; and

FIG. 5 shows an exemplary schematic diagram of control circuitry in a power controller for specifying power control functions to be executed by the power controller in response to a digital control signal.

### DETAILED DESCRIPTION OF EMBODIMENTS OF THE INVENTION

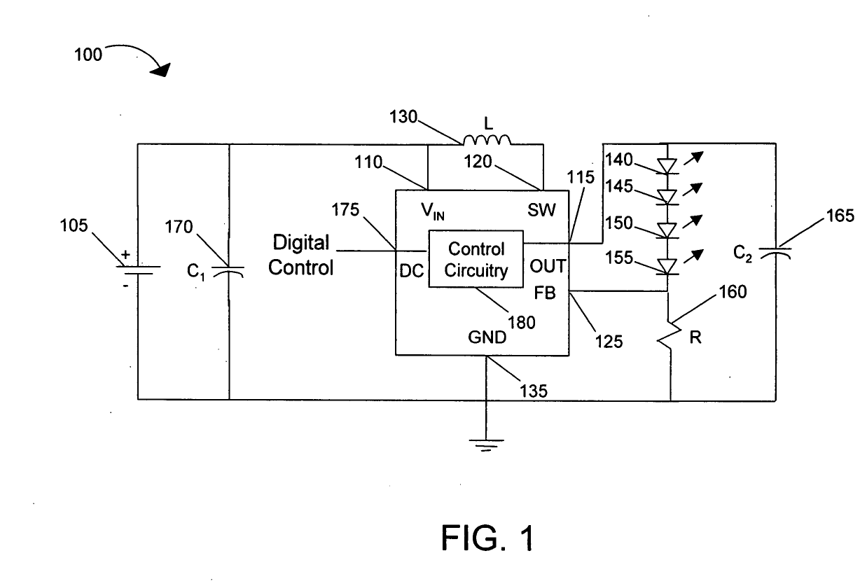

An exemplary schematic diagram of a power controller designed in accordance with the present invention is provided in FIG. 1. Power controller 100 receives an input voltage provided from power source 105 at input pin 110 and generates a regulated voltage at output pin 115. Power controller 100 also has switch node input pin “SW” (pin 120) and output voltage sense or feedback input pin “FB” (pin 125) connected to inductor 130. Input pin 135 serves as the ground.

The regulated voltage generated at output pin 115 is delivered to a load, such as the sting of light emitting diodes (“LEDs”) 140, 145, 150, and 155. Additional components may include an RC network formed by resistor 160 and capacitor 165 connected to the load and capacitor 170 connected to power source 105.

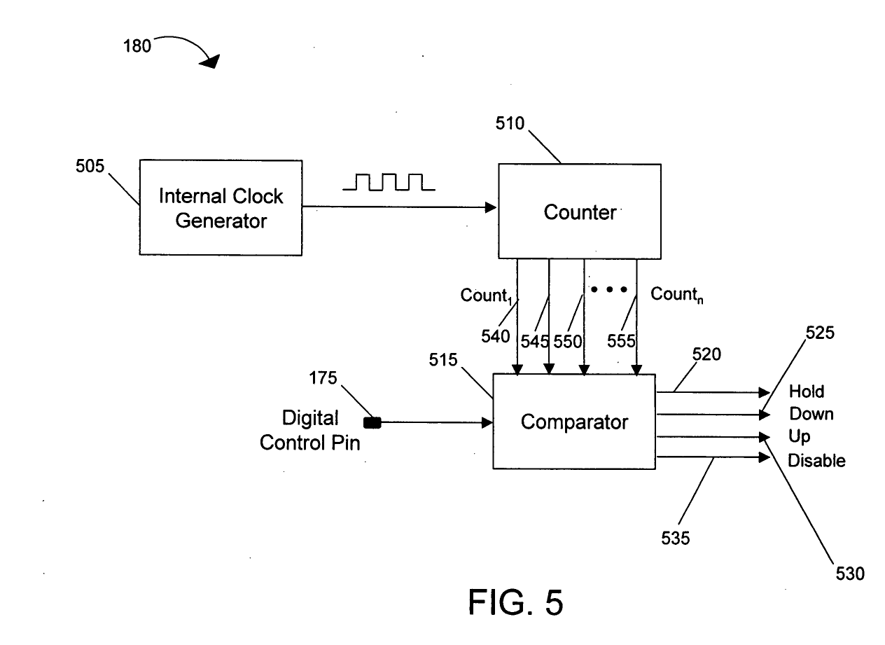

Power controller 100 has a single digital control (“DC”) pin, DC pin 175, that receives a digital control signal for specifying power control functions to be executed by power controller 100 according to control circuitry 180, described in more detail hereinbelow with reference to FIG. 5. Such functions may include, for example, adjusting the output voltage or current delivered to the load, i.e., increasing or reducing the brightness of LEDs 145, 150, 155, and 160, and controlling the power up and shutdown of power controller 100, among others. Power controller 100 also has an internal enable signal (not shown) to enable the delivery of the regulated voltage at output pin 115.

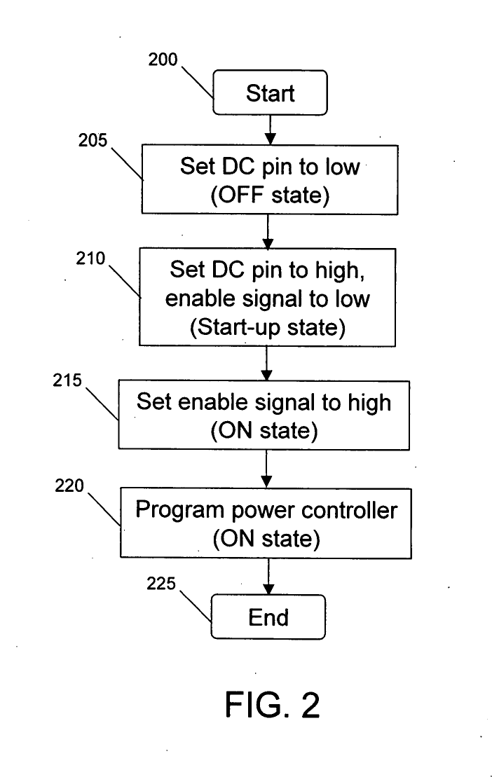

A flowchart illustrating how power controller 100 is controlled by single DC pin 175 in accordance with the present invention is provided in FIG. 2. Initially power controller 100 is turned off and considered to be in a shutdown state. In this state, power controller 100 draws very little current from power source 105, in the order of micro Amperes. Both DC pin 175 and the internal enable signal are set to a low logic level at this state (step 205).

Power controller 100 may be activated by setting DC pin 175 to a high logic level (step 210). In this start-up state, the internal circuitry of power controller 100 is active but power is not delivered to the load as long as the internal enable signal remains set to a low logic level. Power controller 100 may be programmed during this state as needed by toggling DC pin 175 as described in more detail below.

Power is delivered to the load by setting the internal enable signal to a high logic level at step 215. In this “ON” state, power controller 100 is fully activated and operational, and DC pin 175 may be used to specify power control functions to be executed by power controller 100 (step 220).

The power control functions may be specified by toggling DC pin 175 between low and high logic levels within a given time window. The number of high pulses within that given time window or the negative going edge of a high pulse of a certain duration may be used to identify which power control function power controller 100 should execute.

For example, a high pulse of Tₕ in duration with a minimum off time of T_{off} between pulses may be used to indicate that an adjustment in the power delivered to the load is to be made by power controller 100, such as increasing or decreasing the amount of power delivered to the load by a given amount.

To specify whether the power is to be increased or decreased, DC pin 175 may be held low for varying periods of time. The duration of time at which DC pin 175 is held low indicates the power control function to be executed by power controller 100 the next time DC pin 175 is toggled between low and high logic levels. For example, DC pin 175 may be held low for a time duration of Tₛ to shutdown power controller 100, DC pin 175 may be held low for a time duration of Tᵤₚ to increase the power delivered to the load, or DC pin 175 may be held low for a time duration of T_{down} to decrease the power delivered to the load, with Tₛ being the longest time DC pin 175 is held low to indicate a power control function.

Additionally, power controller 100 may be held in its programmed state for a time duration of T_{hold} by setting DC pin 175 to high. During this period, power controller 100 maintains the power delivered to the load and performs no changes or adjustments to its power delivery functions.

It is appreciated that the low and high logic levels may be interchanged without deviating from the scope of the invention. It is also understood that DC pin 175 may receive other control signals to specify additional power control functions.

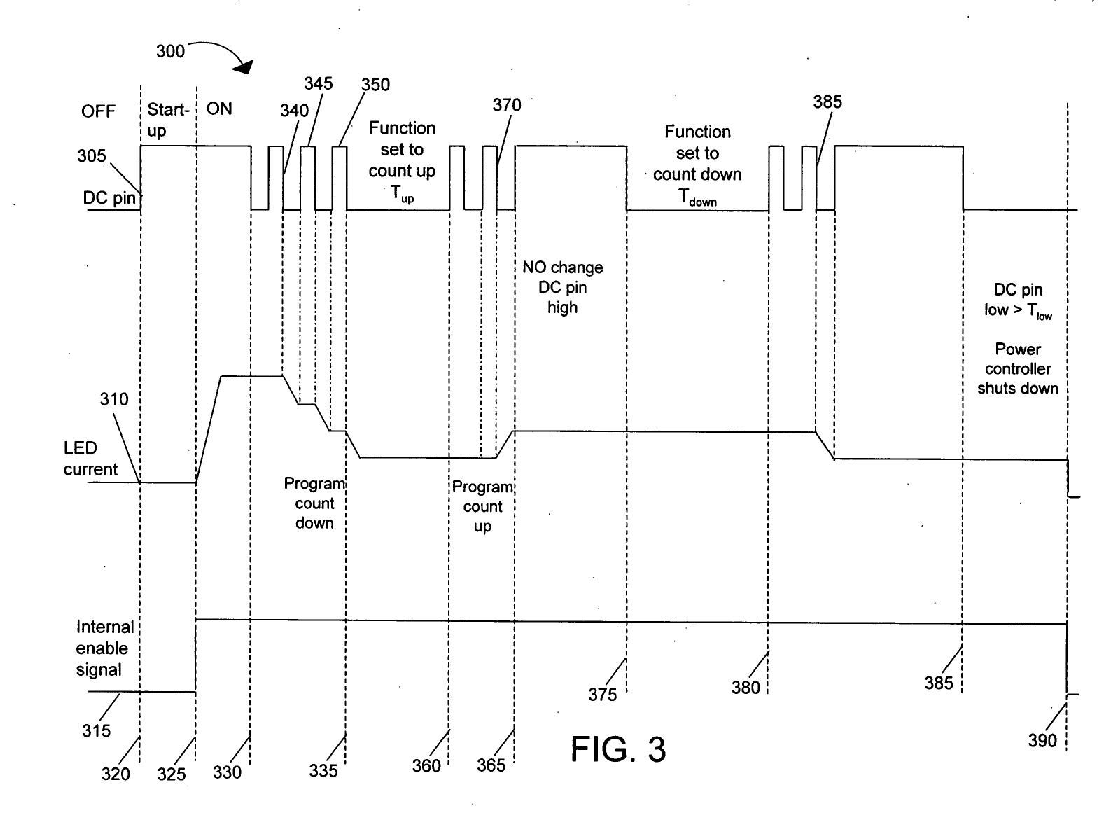

An exemplary timing diagram illustrating the operation of power controller 100 in response to a digital control signal in accordance with the flow chart of FIG. 2 is shown in FIG. 3. Timing diagram 300 shows the state of a digital control signal received by DC pin 175 to control the function of power controller 100 at timing diagram 305, the resulting LED current that is delivered to the load, e.g., LEDs 140, 145, 150, and 155, at timing diagram 310, and the internal enable signal of power controller 100 at timing diagram 315.

At timing interval 320, power controller 100 is off and in a shutdown state. To activate power controller 100, DC pin 175 is set to a high logic level at timing interval 325. During this start-up state, only DC pin 175 is set to a high logic level the internal enable pin is still held low and no power is delivered to the load.

The internal enable signal is set to a high logic level at timing interval 325 after DC pin 175 has been held at a high logic level for more than a given duration of time. Power controller 100 then starts delivering power to the load. In particular, power controller 100 is in its “ON” state, when it is fully activated and operational. Power is delivered to the load by, for example, increasing the LED current up to a desired level. In this state, DC pin 175 may be used to specify power control functions to be executed by power controller 100.

This is first achieved by toggling DC pin 175 at timing interval 335. Initially DC pin 175 is held low for a short period of time of T_{off} indicative of time between pulses. DC pin 175 is subsequently held high for a time period of Tₕ indicative of a high pulse. During times T_{off} and Tₕ, the LED current is held constant as power controller 100 does not yet know when DC pin 175 is held low after timing interval 330 if a power control function is to be specified by a subsequent high pulse or if DC pin 175 is to remain low for a timing period of Tₛ indicative of a shutdown.

That is, the first falling edge of DC pin 175 at timing interval 335 is ignored by power controller 100 so that power controller 100 can confirm which power control function is to be performed next before executing the power control function. Because DC pin 175 is held low only for a period of time of T_{off} and is followed by a high pulse during time Tₕ, power controller 100 is able to confirm that DC pin 175 is indeed being toggled and that a power control function is to be executed.

Upon encountering falling edge 340 of this high pulse, i.e., upon encountering the second falling edge within timing interval 335, power controller 100 is able to confirm that a power control function is to be executed because DC pin 175 is being toggled between a low and a high logic level. Indeed, after falling edge 340, DC pin 175 is brought low again for another period of time of duration T_{off} and is subsequently toggled with two additional high pulses, i.e., high pulse 345 and high pulse 350.

Upon hitting the falling edge of each high pulse, power controller 100 executes a power control function, specifically, power controller 100 executes the default power function after the initial start-up state. The default power function may be, for example, a function to lower the power delivered to the load. That is, power controller 100 lowers the LED current being delivered to LEDs 140, 145, 150, and 155 as shown during timing interval 335 at timing diagram 310.

After DC pin 175 is toggled with two additional high pulses, i.e., high pulses 345 and 350, DC pin 175 is set to a low logic level for a time period of Tᵤₚ at timing interval 360 to set the next power control function to be executed by power controller 100 to a function to increase the power delivered to the load. DC pin 175 is then again toggled between a low and high logic levels for power controller 100 to increase the power delivered to the load.

Specifically, power controller 100 again waits for the second falling edge at timing interval 365, i.e., falling edge 370, to confirm that it is to execute the function of increasing the power delivered to the load. After falling edge 370, power controller 100 starts increasing the LED current delivered to LEDs 140, 145, 150, and 155 as shown during timing interval 365 at timing diagram 310.

At subsequent timing interval 375, DC pin 175 is set to a high logic level and remains unchanged for a time period of T_{hold} to maintain the power delivered to the load. During this time period, power controller 100 maintains the LED current delivered to LEDs 140, 145, 150 and 155 as shown at timing diagram 310.

After the time period of T_{hold}, DC pin 175 is set to low for a time duration of T_{down} at timing interval 380 to set the next power control function to be executed by power controller 100 to a function to decrease the power delivered to the load. DC pin 175 is then again toggled between a low and high logic levels for power controller 100 to decrease the power delivered to the load. Power controller 100 again waits for the second falling edge, i.e., falling edge 385, to decrease the LED current delivered to LEDs 140, 145, 150, and 155 as shown at timing diagram 310.

DC pin 175 is then set to a high logic level at timing interval 385 for a time duration of T_{hold} to maintain the power delivered to the load. During this timing interval, power controller 100 maintains the LED current delivered to LEDs 140, 145, 150 and 155 as shown at timing diagram 310.

When DC pin 175 is set to a low logic level for a time duration of at least Tₛ at subsequent timing interval 390, power controller 100 starts to shutdown. The shutdown is taken into effect when the internal enable signal is sent to a low logic level, as shown in timing diagram 315. At that point, power controller 100 cuts off the LED current delivered to LEDs 140, 145, 150, and 155. No power is delivered to the load and power controller 100 is turned OFF.

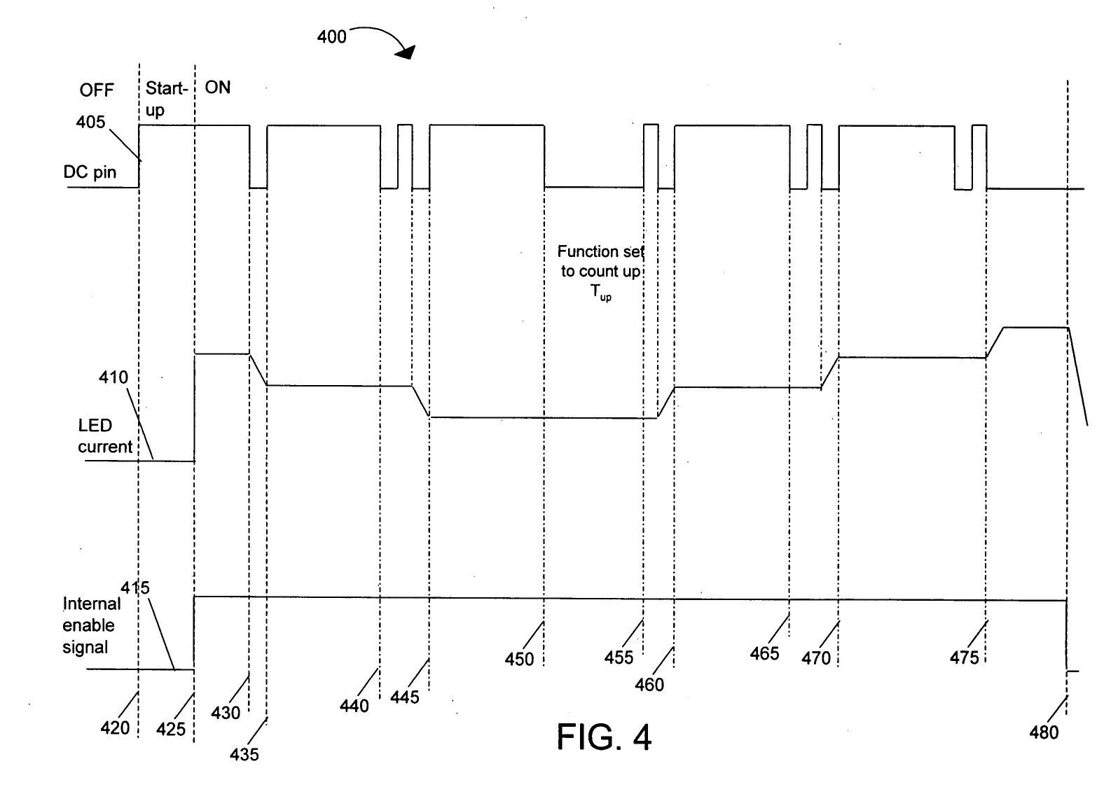

Another exemplary timing diagram illustrating the operation of power controller 100 in response to a digital control signal is shown in FIG. 4. Timing diagram 400 shows the state of a digital control signal received by DC pin 175 to control the function of power controller 100 at timing diagram 405, the resulting LED current that is delivered to the load, e.g., LEDs 140, 145, 150, and 155, at timing diagram 410, and the internal enable signal of power controller 100 at timing diagram 415.

At timing interval 420, power controller 100 is off and in a shutdown state. To activate power controller 100, DC pin 175 is set to a high logic level at timing interval 425. During this start-up state, only DC pin 175 is set to a high logic level; the internal enable pin is still held low and no power is delivered to the load.

The internal enable signal is set to a high logic level at timing interval 430 after DC pin 175 has been held at a high logic level for more than a given duration of time. Power controller 100 then starts delivering power to the load. In particular, power controller 100 is in its “ON” state, when it is fully activated and operational. Power is delivered to the load by, for example, setting the LED current at a desired level. In this state, DC pin 175 may be used to specify power control functions to be executed by power controller 100.

This is first achieved at timing interval 435 by setting DC pin 175 to low for a short period of time of T_{off} indicative of the time between pulses. Here, however, instead of waiting for a pulse and a second falling edge to confirm which power control function to execute, power controller 100 may start executing a default power control function that is activated the first time DC pin 175 goes low in the “ON” state. In this case, the default power control function is to lower the power delivered to the load, as reflected at timing diagram 405.

DC pin 175 is then set to a high logic level at timing interval 440 for a time duration of T_{hold} to maintain the power delivered to the load. During this timing interval, power controller 100 maintains the LED current delivered to LEDs 140, 145, 150 and 155 as shown at timing diagram 410.

Next, DC pin 175 is toggled between a low and high logic levels to specify another power control function to be executed by power controller 100. First, DC pin 175 is held low for a short period of time of T_{off} indicative of the time between pulses. DC pin 175 is subsequently held high for a time period of Tₕ indicative of a high pulse. During times T_{off} and Tₕ, the LED current is held constant as power controller 100 does not yet know when DC pin 175 is held low after timing interval 440 if a power control function is to be specified by a subsequent high pulse or if DC pin 175 is to remain low for a timing period of Tₕ indicative of a shutdown.

That is, the first falling edge of DC pin 175 at timing interval 445 is ignored by power controller 100 so that power controller 100 can confirm which power control function is to be performed next before executing the power control function. Because DC pin 175 is held low only for a period of time of T_{off} and is followed by a high pulse during time Tₕ, power controller 100 is able to confirm that DC pin 175 is indeed being toggled and that a power control function is to be executed.

Upon encountering the falling edge of this high pulse, i.e., upon encountering the second falling edge within timing interval 445, power controller 100 is able to confirm that a power control function is to be executed because DC pin 175 is being toggled between a low and a high logic level. Indeed, after the falling edge of the first high pulse in timing interval 445, DC pin 175 is brought low again for another period of time of duration T_{off}.

At the next timing interval (timing interval 450), DC pin 175 is again set to a high logic level at timing interval for a time duration of T_{hold} to maintain the power delivered to the load. During this timing interval, power controller 100 maintains the LED current delivered to LEDs 140, 145, 150 and 155 as shown at timing diagram 410.

DC pin 175 is then set to a low logic level for a time period of Tᵤₚ at timing interval 455 to set the next power control function to be executed by power controller 100 to a function to increase the power delivered to the load. After that, DC pin 175 is again toggled between a low and high logic levels at timing interval 460 for power controller 100 to increase the power delivered to the load. Unlike timing diagram 310 shown in FIG. 3, however, timing diagram 410 shows that power controller 100 immediately starts increasing the LED current upon encountering the first falling edge in timing interval 455. This may be an alternative to waiting for the second falling edge within a timing interval to start the execution of a power control function.

At the next timing interval (timing interval 465), DC pin 175 is again set to a high logic level at timing interval for a time duration of T_{hold} to maintain the power delivered to the load. During this timing interval, power controller 100 maintains the LED current delivered to LEDs 140, 145, 150 and 155 as shown at timing diagram 410.

DC pin 175 is subsequently toggled between low and high logic levels at timing interval 470 for power controller 100 to again increase the power delivered to the load. This time, however, power controller 100 waits for confirmation that a power controller function is to be executed, that is, power controller 100 waits for the second falling edge within the timing interval to start increasing the LED current delivered to the load.

Subsequent timing interval 475 follows a similar sequence of events, with DC pin 175 again set to a high logic level at timing interval for a time duration of T_{hold} to maintain the power delivered to the load and then toggled between low and high logic levels to increase the power delivered to the load.

After that, DC pin 175 is set to a low logic level for a time duration of at least Tₛ (timing interval 480) so that power controller 100 starts to shutdown. The shutdown is taken into effect when the internal enable signal is sent to a low logic level, as shown in timing diagram 415. At that point, power controller 100 cuts off the LED current delivered to LEDs 140, 145, 150, and 155. No power is delivered to the load and power controller 100 is turned OFF.

The behavior of power controller 100 shown in timing diagrams 300 (FIG. 3) and 400 (FIG. 4) may be emulated with the exemplary control circuitry shown in FIG. 5. Control circuitry 180 has internal clock generator 505 coupled to counter 510, which is coupled to comparator 515. Comparator 515 has DC pin 175 as an input and generates a number of outputs corresponding to power control functions that may be executed by power controller 100, e.g., output 520 corresponding to a “HOLD” power control function to maintain the power delivered to the load, output 525 corresponding to a “DOWN” power control function to decrease the power delivered to the load, output 530 corresponding to an “UP” power control function to increase the power delivered to the load and output 535 corresponding to a “DISABLE” power control function to disable or shutdown power controller 100.

Comparator 515 also receives a number of inputs from counter 510, such as counter outputs 540, 545, 550, and 555. These counter outputs are compared against the width of the signal input at DC pin 175 by comparator 515. If the pulse width of the signal input at DC pin 175 lies within the specified number of counts corresponding to a time period set for a given power control function, comparator 515 asserts the appropriate power control function output to high.

For example, internal clock generator 505 generates a pulse train with a given period, e.g., 1 μs, that serves as an input clock to a counter. Each counter output may be asserted to high when internal clock generator 505 has generated a number of pulses corresponding to a time duration for specifying a given power control function. The time durations may be, for example, Tᵤₚ for increasing the power to be delivered to the load, T_{down} for decreasing the power to be delivered to the load, T_{off} for the time duration between high pulses during a toggle of DC pin 175, Tₕ for the time duration corresponding to a high pulse during a toggle of DC pin 175, Tₛ for shutting down power controller 100, and T_{hold} for maintaining the power delivered to the load, among others.

When a given number of pulses is generated by internal clock generator 505 that corresponds to a given time duration, a counter output is asserted high. If the counter output matches the pulse width of the signal input at DC pin 175, comparator 515 asserts the appropriate power control function to high. For example, assuming Tₛ is 1500 μs, a counter output is asserted to high when internal clock generator generates 1500 pulses of 1 μs in duration each. If DC input signal 175 is held low for 1500 μs, comparator 515 asserts the output corresponding to the shutdown power control function to high to instruct power controller 100 to shutdown its operation.

It is understood that control circuitry 180 may include additional inputs, outputs, and circuit components to implement the principles and embodiments of the present invention set forth hereinabove. For example, control circuitry 180 may include a comparator that has additional outputs corresponding to additional power control functions that may be executed by power controller 100.

Advantageously, power controller 100 is able to control the amount of power delivered to a load with a single digital control pin and a simple control circuit. The single digital control pin can be toggled between different states to specify different power control functions that may be executed by the power regulator, providing designers with a flexible, yet powerful, method to regulate power delivery to a load.

The foregoing descriptions of specific embodiments and best mode of the present invention have been presented for purposes of illustration and description only. They are not intended to be exhaustive or to limit the invention to the precise forms disclosed. Specific features of the invention are shown in some drawings and not in others, for purposes of convenience only, and any feature may be combined with other features in accordance with the invention. Steps of the described processes may be reordered or combined, and other steps may be included. The embodiments were chosen and described in order to best explain the principles of the invention and its practical application, to thereby enable others skilled in the art to best utilize the invention and various embodiments with various modifications as are suited to the particular use contemplated. Further variations of the invention will be apparent to one skilled in the art in light of this disclosure and such variations are intended to fall within the scope of the appended claims and their equivalents.

What is claimed is:

1. A power regulator for delivering power to a load, comprising control circuitry having a single digital control pin for controlling the amount of power delivered to the load, the control circuitry being configured to set the single digital control pin to a first logic state for a first predetermined amount of time to specify a first power control function to be executed by the control circuitry by toggling the single digital control pin between the first logic state and a second logic state.

2. The power regulator of claim 1, wherein the control circuitry is further configured to set the single digital control pin to a second logic state for a second programmable amount of time to specify a second power control function to be executed by the power regulator by toggling the single digital control pin between the first logic state and the second logic state.

3. The power regulator of claim 1, wherein the first power control function comprises a control function for reducing the amount of power delivered to the load.

4. The power regulator of claim 1, wherein the second power control function comprises a control function for increasing the amount of power delivered to the load.

5. A power regulator for controlling power delivery to a load, comprising control circuitry having an internal clock generator for generating a pulse train having a pulse period and a counter coupled to the internal clock generator for counting pulses in the pulse train and generating a plurality of outputs that include the pulse counts, a single digital control pin coupled to the control circuitry for relaying instructions to the control circuitry, the single digital control pin being settable between first and second logic states, and the control circuitry including a comparator coupled to the counter and to the single digital control pin for comparing the plurality of outputs from the counter to the logic states at the single digital control pin within a time window and delivering instructions to the control circuitry as a function of such comparison.

6. The power regulator of claim 5, wherein the control circuitry is configured to start up when the single digital control pin is set to a first logic state.

7. The power regulator of claim 5, wherein the control circuitry is configured to execute a power control function when the single digital control pin is set to a second logic state for a first predetermined amount of time.

8. The power regulator of claim 7, wherein the control circuitry is configured to instruct the power regulator to execute the power control function when the single digital control pin is toggled between the first and second logic states.

9. The power regulator of claim 8, wherein the control circuitry is configured to instruct the power regulator to maintain the amount of power delivered to the load when the single digital control pin is set to the first logic state for a second programmable amount of time after execution of the power control function.

10. The power regulator of claim 9, wherein the control circuitry is configured to instruct the power regulator to shutdown when the single digital control pin is set to the second logic state for a third programmable amount of time.

11. The power regulator of claim 5, wherein each output from the plurality of outputs corresponds to a pulse period.

12. The power regulator of claim 5, wherein the comparator includes a plurality of control signals corresponding to a plurality of power control functions.

13. A method for controlling power delivery by a power regulator for use with a load, comprising providing a single digital control pin on the power regulator, setting the single digital control pin to a first logic state to send a first instruction to the power regulator and setting the single digital control pin to a second logic state to send a second instruction to the power regulator.

14. The method of claim 13, wherein the first instruction is to start up the power regulator.

15. The method of claim 14, wherein the second instruction is to enable the power regulator to execute a first power control function.

16. The method of claim 15, further comprising the step of toggling the single digital control pin between the first logic state and the second logic state to cause the power regulator to execute the first power control function and thus deliver a level of power to the load.

17. The method of claim 16, further comprising the step of setting the single digital control pin to the first logic state after the toggling step to maintain the level of power delivered to the load.

18. The method of claim 17, further comprising the step of setting the single digital control pin to the second logic state after the toggling step for a predetermined amount of time for shutting down the power regulator.

19. A method for controlling power delivery by a power regulator for use with a load, comprising providing a single digital control pin on the power regulator, setting the single digital control pin to a first logic state for starting up the power regulator, setting the single digital control pin to a second logic state for a first predetermined amount of time to enable the power regulator to execute a first power control function, toggling the single digital control pin between the first logic state and the second logic state to cause the power regulator to execute the first power control function and thus deliver a level of power to the load, setting the single digital control pin to the first logic state to maintain the level of power delivered to the load, and setting the single digital control pin to the second logic state for a second predetermined amount of time for shutting down the power regulator.

20. The method of claim 19, further comprising providing a power enable signal internal to the power regulator for enabling power delivery to a load and setting the power enable signal to the first logic state for delivering power to the load.

21. The method of claim 19, further comprising setting the single digital control pin to the second logic state for a third programmable amount of time to specify a second power control function to be programmed by the power regulator.

22. The method of claim 21, further comprising executing the second power control function by toggling the single digital control pin between the first logic state and the second logic state.

23. The method of claim 19, wherein executing the first power control function by toggling the single digital control pin between a first logic state and a second logic state includes changing the amount of power delivered to the load based on the number of toggles between the first logic state and the second logic state.

24. The method of claim 22, wherein executing the second power control by toggling the single digital control pin between the first logic state and the second logic state includes changing the amount of power delivered to the load based on the number of toggles between the first logic state and the second logic state.

25. The method of claim 19, further comprising setting the first programmable amount of time and the third programmable amount of time lower than the second programmable amount of time.

26. The method of claim 19, wherein executing the first power control function comprises reducing the amount of power delivered to the load.

27. The method of claim 22, wherein executing the second power control function comprises increasing the amount of power delivered to the load.
